(19) United States
(12) Patent Application Publication
(10) Pub. No.: US 2019/0130047 A1
(43) Pub. Date: May 2, 2019

(54) CENTRALIZED CLIENT-SIDE COMPONENT FOR RETRIEVING REMOTE CONTENT ITEMS

(71) Applicant: Microsoft Technology Licensing, LLC, Redmont, WA (US)

(72) Inventors: Swetha Karthik, Sunnyvale, CA (US); John Moore, Sunnyvale, CA (US); Chiachi Lo, Santa Clara, CA (US)

(21) Appl. No.: 15/799,996

(22) Filed: Oct. 31, 2017

(51) Int. Cl. G06F 17/30; H04L 29/08

(52) U.S. Cl. CPC G06F 17/30896; H04L 67/025; G06F 17/30643; G06F 17/30873

(57) ABSTRACT

Techniques for centralizing client-side logic for retrieving remote content items are provided. In one technique, a client device receives, from a server, data that includes first code and a web document. The data is processed at the client device, which processing comprises analyzing the web document to identify a first component that specifies multiple data items and executing code associated with the first component to generate a first reference that is based on the multiple data items, generate a first executable element, and insert the first reference into the first executable element. The first executable element is executed at the client device, wherein executing the first executable element causes a first request that includes the first reference to be transmitted over a network. In response to the first request, a first content item is received and displayed within a web page that is rendered based on the web document.

### TECHNICAL FIELD

The present invention relates generally to transmission of content items over computer networks and, more particularly, to improving system performance and easing the burden on web developers in retrieving content items. SUGGESTED CLASSIFICATION: 709/203; SUGGESTED ART UNIT: 2447.

### BACKGROUND

The Internet allows end-users operating computing devices to request content from many different publishers. Some publishers desire to send additional content items to users who visit their respective websites or who otherwise interact with the publishers. To do so, publishers may rely on an internal content delivery service or an external content delivery service that delivers the additional content items over one or more computer networks to computing devices of such users. One approach for interacting with a content delivery service is for a developer to develop a web application that hard codes an API call for each additional content item. For example, if a web page is to include six additional content items, then a developer composes an iframe that references a particular endpoint (whether a frontend server or a backend server). If a web domain supports multiple web applications and each web application is built by a different team of developers, then different people will hard code the API calls. One problem with this approach is that there is no consistent way of making the calls. For example, some developers may reference a frontend server and others may reference a backend server. Another problem with this approach is that the call logic is spread across potentially many frontend web pages. This not only can lead to inconsistency and errors, but maintenance of these API calls becomes difficult as the API definition needs to be extended to support newer use cases across various web application/web pages over a period of time.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2A is a block diagram that depicts a first example client-server architecture;

FIG. 2B is a block diagram that depicts a second example client-server architecture, in an embodiment;

FIG. 2C is a flow diagram that depicts a process for generating content requests to a frontend server, in an embodiment;

FIG. 3 is a block diagram that depicts an example layout 300 of various zones within a web page, in an embodiment;

FIG. 4A depicts an example layout of components for a particular web page, in an embodiment;

FIG. 4B depicts a screenshot of a first example web page that is generated based on the example layout;

FIG. 4C depicts an example layout of components for the same web page as in FIG. 4A, except with additional components for retrieving additional content items, in an embodiment;

FIG. 4D depicts a screenshot of a second example web page that is similar to the first example web page, except for content items that are retrieved in response to executing client-side components, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for centralizing client-side logic for retrieving remote content items are provided. Even though different developers may build different web applications, a developer adds a (e.g., JavaScript) component to her respective web application without having to specify any calls to a remote server. The component may include one or more page (and/or placement) specific parameters. A content item manager executing on a client device identifies the component and may add additional parameters. The component itself generates a resource locator (e.g., a URL) based on the parameters associated with the component, creates an executable element (e.g., an iframe), and includes the resource locator in the executable element. Thereafter, a browser (executing on the client device) processes the executable element, which causes the resource locator (along with the parameters) to be transmitted over a network to a frontend server (which is remote, relative to the client device.

The above approach has multiple technical advantages, which include code centralization (i.e., for making content item requests), ease of integration and maintenance, enhanced performance, and flexibility for future enhancements.

### System Overview

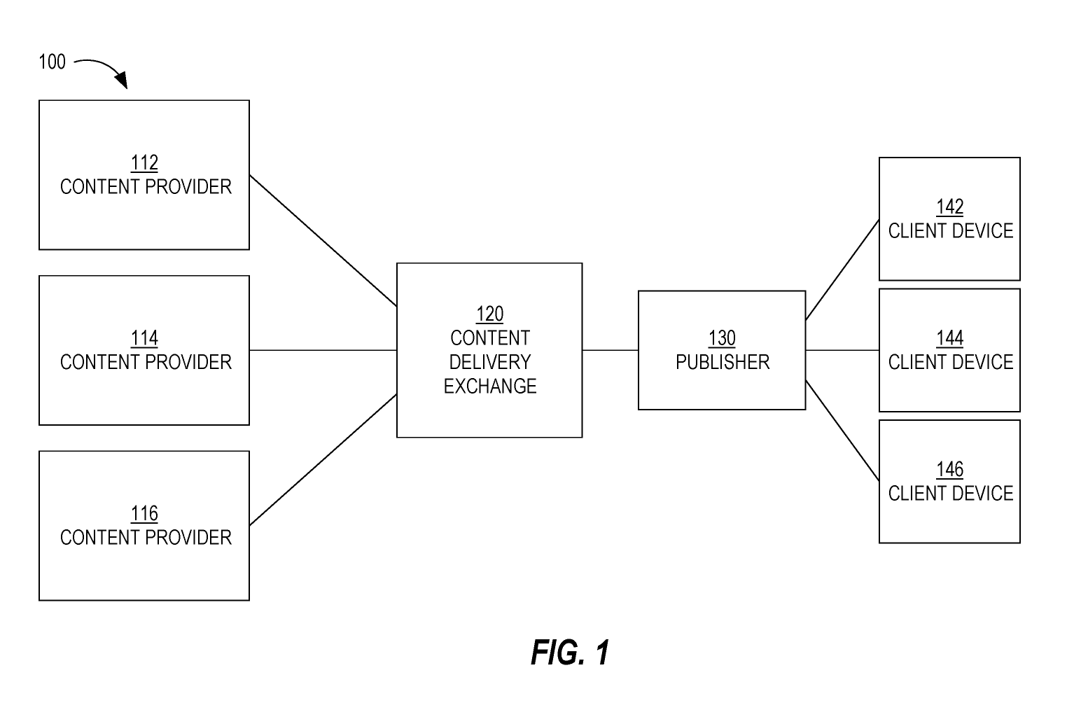

FIG. 1 is a block diagram that depicts a system 100 for distributing content items to one or more end-users, in an embodiment. System 100 includes content providers 112-116, a content delivery exchange 120, a publisher 130, and client devices 142-146. Although three content providers are depicted, system 100 may include more or less content providers. Similarly, system 100 may include more than one publisher and more or less client devices.

Content providers 112-116 interact with content delivery exchange 120 (e.g., over a network, such as a LAN, WAN, or the Internet) to enable content items to be presented, though publisher 130, to end-users operating client devices 142-146. Thus, content providers 112-116 provide content items to content delivery exchange 120, which in turn selects content items to provide to publisher 130 for presentation to users of client devices 142-146. However, at the time that content provider 112 registers with content delivery exchange 120, neither party may know which end-users or client devices will receive content items from content provider 112, unless a target audience specified by content provider 112 is small enough.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end-users, either through publishers directly or indirectly through content delivery exchange 120.

Although depicted in a single element, content delivery exchange may comprise multiple computing elements and devices, connected in a local network or distributed regionally or globally across many networks, such as the Internet. Thus, content delivery exchange 120 may comprise multiple computing elements, including file servers and database systems.

Publisher 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher 130 (and/or its affiliates). A content request may be a request that is immediately preceded by user input (e.g., selecting a hyperlink on web page) or may initiated as part of a subscription, such as through a Rich Site Summary (RSS) feed. In response to a request for content from a client device, publisher 130 provides the requested content (e.g., a web page) to the client device.

Simultaneously or immediately before or after the requested content is sent to a client device, a content request is sent to content delivery exchange 120. That request is sent (over a network, such as a LAN, WAN, or the Internet) by publisher 130 or by the client device that requested the original content from publisher 130. For example, a web page that the client device renders includes one or more calls (or HTTP requests) to content delivery exchange 120 for one or more content items. In response, content delivery exchange 120 provides (over a network, such as a LAN, WAN, or the Internet) one or more particular content items to the client device directly or through publisher 130. In this way, the one or more particular content items may be presented (e.g., displayed) concurrently with the content requested by the client device from publisher 130.

In response to receiving a content request, content delivery exchange 120 initiates a content item selection event that involves selecting one or more content items (from among multiple content items) to present to the client device that initiated the content request. An example of a content item selection event is an auction.

Content delivery exchange 120 and publisher 130 may be owned and operated by the same entity or party. Alternatively, content delivery exchange 120 and publisher 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 120, and that bids for space (on one or more publishers, such as publisher 130) to present content items on behalf of multiple content providers. Thus, a bidder is another source of content items that content delivery exchange 120 may select for presentation through publisher 130. Thus, a bidder acts as a content provider to content delivery exchange 120 or publisher 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery exchange 120. A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view the set of content items, select or click on the set of content items, or when a certain number of users purchase a product/service associated with the content delivery campaign or fill out a particular form on a website.

A content delivery campaign may specify one or more targeting criteria that are used to determine whether to present a content item of the content delivery campaign to one or more users. Example factors include date of presentation, time of day of presentation, characteristics of a user to which the content item will be presented, attributes of a computing device that will present the content item, identity of the publisher, etc. Examples of characteristics of a user include demographic information, residence information, job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), current geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 120 receives, from a computing device, a request that does not satisfy the targeting criteria, then content delivery exchange 120 ensures that any content items associated with the particular content delivery campaign are not sent to the computing device.

Thus, content delivery exchange 120 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery campaign 120 may select a strict subset of the identified content delivery campaigns from which content items will be identified and presented to the user of the computing device.

Instead of one set of targeting criteria, a single content delivery campaign may be associated with multiple sets of targeting criteria over time. For example, one set of targeting criteria may be used during one period of time of the content delivery campaign and another set of targeting criteria may be used during another period of time of the campaign.

Different content delivery campaigns that content delivery exchange 120 manages may have different charge models. For example, content delivery exchange 120 may charge a content provider of one content delivery campaign for each presentation of a content item from the content delivery campaign (referred to herein as cost per impression or CPM). Content delivery exchange 120 may charge a content provider of another content delivery campaign for each time a user interacts with a content item from the content delivery campaign, such as selecting or clicking on the content item (referred to herein as cost per click or CPC). Content delivery exchange 120 may charge a content provider of another content delivery campaign for each time a user performs a particular action, such as purchasing a product or service, downloading a software application, or filling out a form (referred to herein as cost per action or CPA). Content delivery exchange 120 may manage only campaigns that are of the same type of charging model or may manage campaigns that are of any combination of the three types of charging models.

A content delivery campaign may be associated with a resource budget that indicates how much the corresponding content provider is willing to be charged by content delivery exchange 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items are considered and a subset selected for presentation on a computing device in response to a request. Thus, each content request that content delivery exchange 120 receives triggers a content item selection event.

For example, in response to receiving a content request, content delivery exchange 120 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 120 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery exchange 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 120 conducts one or more content item selection events. Thus, content delivery exchange 120 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that owns and operates content delivery exchange 120 conducts one or more content item selection events. In this latter embodiment, content delivery exchange 120 sends one or more content items to the other exchange, which selects one or more content items from among multiple content items that the other exchange receives from multiple sources. In this embodiment, content delivery exchange 120 does not know (a) which content item was selected if the selected content item was from a different source than content delivery exchange 120 or (b) the bid prices of each content item that was part of the content item selection event. Thus, the other exchange may provide, to content delivery exchange 120 (or to a performance simulator described in more detail herein), information regarding one or more bid prices and, optionally, other information associated with the content item(s) that was/were selected during a content item selection event, information such as the minimum winning bid or the highest bid of the content item that was not selected during the content item selection event.

### Tracking User Interactions

Content delivery exchange 120 tracks one or more types of user interactions across client devices 142-146 (and other client devices not depicted). For example, content delivery exchange 120 determines whether a content item that content delivery exchange 120 delivers is presented at (e.g., displayed by or played back at) a client device. Such a “user interaction” is referred to as an “impression.” As another example, content delivery exchange 120 determines whether a content item that exchange 120 delivers is selected by a user of a client device. Such a “user interaction” is referred to as a “click.” Content delivery exchange 120 stores such data as user interaction data, such as an impression data set and/or a click data set.

For example, content delivery exchange 120 receives impression data items, each of which is associated with a different instance of an impression and a particular content delivery campaign. An impression data item may indicate a particular content delivery campaign, a specific content item, a date of the impression, a time of the impression, a particular publisher or source (e.g., onsite v. offsite), a particular client device that displayed the specific content item, and/or a user identifier of a user that operates the particular client device. Thus, if content delivery exchange 120 manages multiple content delivery campaigns, then different impression data items may be associated with different content delivery campaigns. One or more of these individual data items may be encrypted to protect privacy of the end-user.

Similarly, a click data item may indicate a particular content delivery campaign, a specific content item, a date of the user selection, a time of the user selection, a particular publisher or source (e.g., onsite v. offsite), a particular client device that displayed the specific content item, and/or a user identifier of a user that operates the particular client device.

### Dynamic Content Items

A “dynamic content item” is a content item that is generated dynamically from user data and/or contextual data. User data (also referred to herein as entity data) may include data from a user's online profile, data describing online activity that the user (or “viewer” or “viewing entity”) has initiated or performed (e.g., searches, web sites visited, and online articles commented, liked, or shared), and/or the user's social data (e.g., the connections of the user, companies the user is following). Contextual data may include data about the page (or content) and the content/ad slot that a viewer requested and through which the content item will be presented (e.g., displayed or played).

For example, when a LinkedIn member views another LinkedIn member's profile, who works for Company X, the viewer can be served (or presented with) a dynamic content item, which may include the text “Picture Yourself at Company X” or text “Work with us at Company X”, along with a logo of Company X, a profile picture of the viewer, a name of the viewer, a list of one or more job titles of job openings (matching the viewer) at Company X, and a location of each job opening.

A content delivery campaign from which one or more dynamic content items originate is referred to herein as a “dynamic campaign.” A dynamic campaign can be created with one or more types of content items and, for each type of content item, one or more formats. Different types of content items support (or are associated with) a different format group of a set of format groups. Such, for content item type A, there is a group of two formats; while for content item type B, there is a group of four formats. Also, the same dynamic campaign may be associated with multiple content items of the same type.

Examples of content item types that a single dynamic campaign may have include “JobsYouMayBeInterestedIn,” “PictureYourself,” “FollowCompany,” and “Spotlight.” Different content item types may be restricted to being displayed on certain web pages. For example, a “PictureYourself” content item, a “JobsYouMayBeInterestedIn” content item, and a “FollowCompany” content item can be displayed on an organization's (e.g., a company's) profile page while a “Spotlight” content item cannot. As another example, only “PictureYourself” and “FollowCompany” content items can be displayed on member profile pages while and “Spotlight” content items can only be displayed on search pages.

A format indicates a “look and feel” of a rendered content item. Different formats may specify that certain types of data items should be presented in a certain way. For example, one format may specify that a job title appears to the right of a person's profile picture while another format may specify that a job title appears immediately above the person's profile picture. Different formats may also specify which types of data items will be displayed at all. For example, one format may specify that a certain background image is to be included, whereas another format may specify that a different background image (or no background image) should be included.

Embodiments described herein are not limited to dynamic content items. Other types and sources of content items are possible, including “text content items” and “display content items.” A text content item is a content item whose content is fixed or static, regardless of the viewer that is viewing the content item. Attributes of the viewer and/or the viewed context may be used in selecting a text content item to display to the viewer, but the content of the content item does not change from viewer to viewer or from context to context. However, like a dynamic content item, a text content item may originate from a content delivery campaign that is managed by an internal content delivery exchange (e.g., content delivery exchange 120). A display content item, on the other hand, is a content item that may originate from a third-party content delivery exchange, which is remote (or “external”) relative to content delivery exchange 120.

### Retrieving Remote Content Items

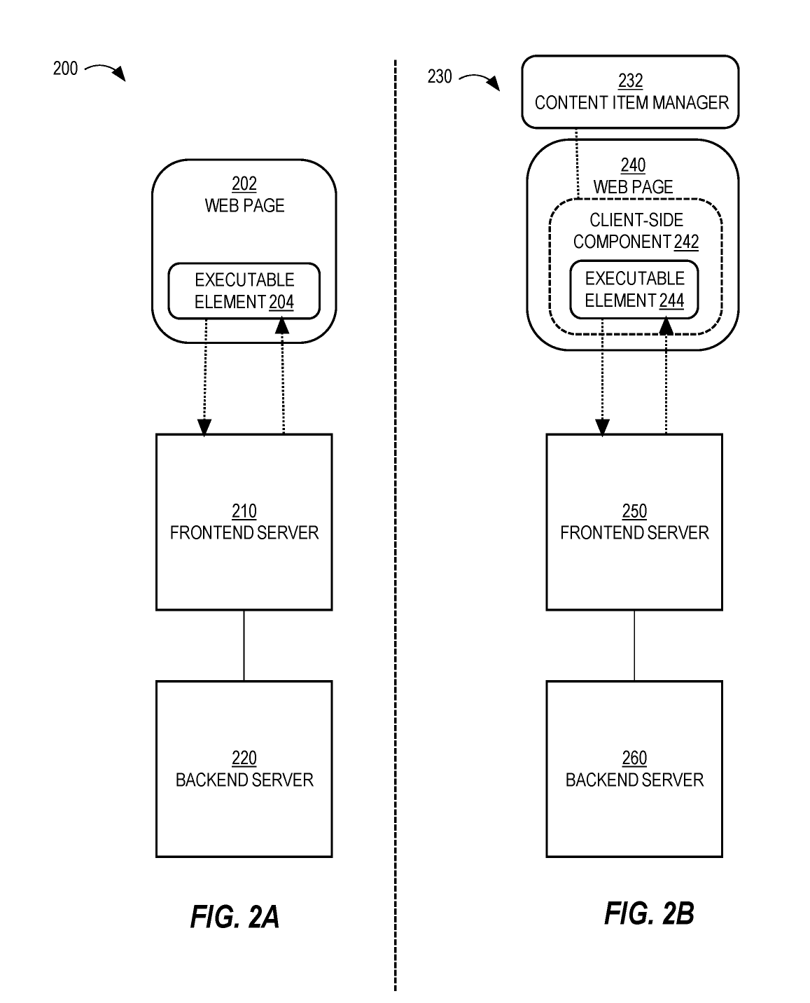

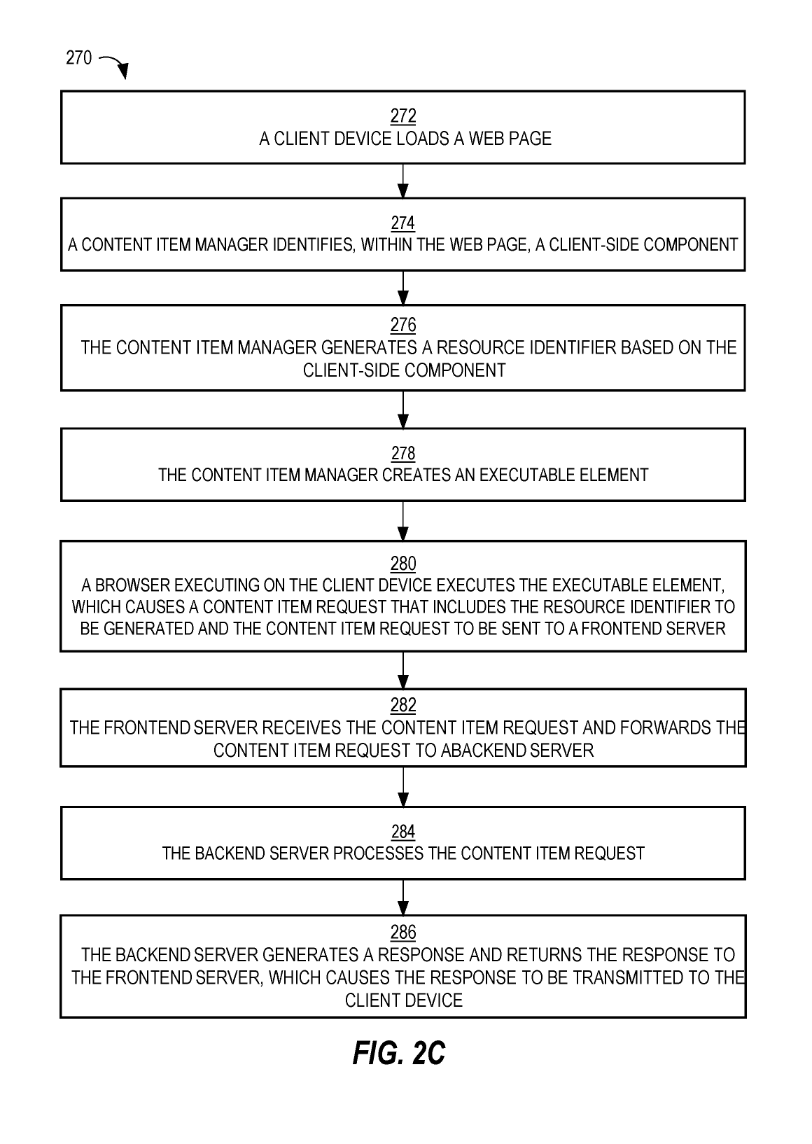

FIG. 2A is a block diagram that depicts an example client-server architecture 200. Client-server architecture 200 comprises a web page 202, a frontend server 210, and a backend server 220. Frontend server 210 and backend server 220 may be part of content delivery exchange 120. Web page 202 is rendered on a client device (e.g., client device 142) and natively includes an executable element 204, which, in this example is an inline frame, or “iframe.” Executable element 204 comprises a reference or URL to frontend server 210. Executable element 204 was specified by a developer of the web application that generated web page 202 (or generated the components of web page 202). An endpoint at frontend server 210 receives a content item request that is generated when executable element 204 is rendered or processed and transmits a response to the content item request when the response is available. Frontend server 210 may receive the response from backend server 220, which may be responsible for identifying (e.g., locally) or retrieving (e.g., remotely) a content item in response to the content item request.

FIG. 2B is a block diagram that depicts a client-server architecture 230, in an embodiment. Client-server architecture 230 comprises a web page 240, a frontend server 250, a backend server 260, and, optionally, a content item manager 232. Frontend server 250 and backend server 260 may be part of content delivery exchange 120. While only a single frontend server 250 is depicted, client-server architecture 230 may include multiple frontend servers, executing on multiple machines. Similarly, while only a single backend server 260 is depicted, client-server architecture 230 may include multiple backend servers, executing on multiple machines.

Client-server architecture 230 may be based on a web framework or web application framework, which is a software framework that is designed to support the development of web applications including web services, web resources, and web APIs. Web frameworks provide a standard way to build and deploy web applications. Web frameworks aim to automate the overhead associated with common activities performed in web development. For example, many web frameworks provide libraries for database access, templating frameworks, and session management, and web frameworks often promote code reuse. An example of a web framework is Ember, which is an open-source JavaScript web framework that is based on the Model-view-viewmodel (MVVM) pattern. Ember allows developers to create scalable single-page web applications by incorporating common idioms and best practices into the framework. A key concept in Ember is a component, which is a custom HMTL tag. Component behavior is implemented using JavaScript and component appearance is defined using HTMLBars templates. Components “own” their data and can be nested and communicate with their parent components through actions (events).

Other key concepts in Ember include routes, models, and templates. Regarding routes, the state of an application is represented by a URL and each URL has a corresponding route object that controls what is visible to the user. Regarding models, every route has an associated model that contains the data associated with the current state of the application. While one can use jQuery to load JSON objects from a server and use those objects as models, most applications use a model library such as Ember Data. Regarding templates, templates are used to build the application's HTML and are written with the HTMLBars templating language. HTMLBars is a variation of Handlebars that builds DOM elements rather than a String.

Examples of alternative web frameworks to Ember include React, Angular, Polymer, Vue, and Aurelia. Embodiments are not limited to any particular web framework.

Web page 240 is rendered on a client device (e.g., client device 142) and includes a client-side component 242, an example of which is an Ember component. Client-side component 242 comprises code (e.g., JavaScript) that is processed to generate an executable element 244 (e.g., an iframe) that references frontend server 250. Client-side component 242 was specified by a developer of the web application that generated web page 240 (or generated the components of web page 240).

FIG. 2C is a flow diagram that depicts a process 270 for generating content requests to frontend server 250, in an embodiment.

At block 272, a client device loads web page 240. The loading may be performed in response to a browser executing on the client device transmitting a request for content to a publisher system. Example browsers include Firefox™, Safari™, Chrome™, and Internet Explorer™. The publisher system receives and processes the request and generates web page 240, which is rendered in the browser. Web page 240 is part of the client (or user interface) of a web application that executes in the browser while the server component of the web application executes at the publisher system. The web application may be implemented as a single-page application or a traditional web application where a page reloads in response to user actions while staying within the same web domain.

At block 274, a client-side component 242 is identified in web page 240. Block 274 may involve analyzing web page 240 for a specific label or set of characters that indicate a client-side component. For example, a browser identifies code that begins with “content-banner” inside double brackets (e.g., {{ }}). Client-side component 242 specifies one or more parameter values and, optionally, names of the corresponding parameters. An example of client-side component 242 is the following:

```
{{content-banner
    slotSize=”700x17”
    zone=”MYNETWORK”
    pageZone=”PAGE_ZONE-HEADER”
}}
```

In this example, the parameters are slot size (indicating a size of the slot or area in which a content item will be displayed), zone (indicating a page type or a specific web application), and page zone (indicating a location or region within the corresponding web page in which a content item will be displayed). Executable (e.g., JavaScript) code (in web page 240) that is separate from the above-specified parameters (1) corresponds to the content-banner component and (2) is identified and executed in order to process the above-specified parameters.

Block 274 may also involve validating the data within client-side component 242, such as whether the specified data values are valid (or expected, such as within a certain range of values or of a certain type of value, such as numeric characters v. alpha characters) and whether the parameter names are valid.

At block 276, client-side component 242 generates a resource identifier based on the parameter values specified in client-side component 242 and, optionally, based on one or more parameter values that client-side component 242 or content item manager 232 determines based on data other than client-side component 242. For example, content item manager 232 may keep track of how many content item requests have been generated for a particular page zone and specify, in the resource identifier, a tile number that indicates which content item in a sequence the corresponding content item request will be for. The resource identifier may specify a slot size, a zone, a page zone, a tile number, and one or more additional parameter values. The resource identifier does not necessarily identify any specific content item, but rather may rather comprise a URL (Uniform Resource Locator) that specifies a web domain (e.g., linkedin.com), an endpoint at frontend server 250 (of which there may be multiple endpoints), and one or more parameter values. An example of a resource identifier is https://www.linkedin.com/csp/dtag?sz=300×250&ti=2&p=1&z=profile&pk=nprofile-view&_x=%3Bcompany %3D1441%3Bpcntry %3Dus, where “dtag” is the endpoint, “sz” is the slot size parameter and “300×250” is the slot size, “ti” is the tile number parameter, “2” is the tile number, “p” is the page zone parameter, “1” is the page zone value. Different resource identifiers that each client-side component generates may indicate different endpoints, different slot sizes, different page zones, and different tiles.

Client-side component 242 may generate a resource identifier that includes or encodes a viewer identifier that identifies a user that requested web page 240 and a contextual identifier that identifies a user or organization (e.g., a company) whose profile information is being presented on web page 240. Such identifiers may be encrypted to preserve privacy.

At block 278, client-side component 242 creates an executable element, such as an iframe, and includes the resource identifier in the executable element.

At block 280, a browser executing on the client device executes the executable element, causing a content item request to be generated (e.g., in the form of an HTTP GET request) and to include the resource identifier, and causing the content item request to be transmitted over a computer network to frontend server 250.

At block 282, frontend server 250 receives the content item request and forwards the content item request (or transmits a related request) to backend server 260. Block 282 may involve frontend server 250 validating the content item request as a precondition to forwarding the content item request. “Forwarding” may involve generating a different content item request that is based on the received content item request, such as removing one or more data items from the content item request and/or adding one or more data items to the content item request, such as a name of a particular destination machine that will process the forwarded content item request.

At block 284, backend server 260 processes the content item request, which may involve conducting a content item selection event to select a content item or sending, to a third-party content delivery exchange, a request for a content item, which exchange will conduct its own content item selection event.

At block 286, backend server 260 generates a response and causes the response to be transmitted to the client device, for example, through frontend server 250. If backend server 260 identifies a content item as part of a content item selection event, then the response may include the content item, or references to one or more data items that make up the content item. If backend server 260 chooses to or does not identify a content item as part of a content item selection event, then the response may include a reference (e.g., a URL) to a third-party content delivery exchange, which reference, when executed by the client device, causes the client device to generate and transmit a content item request to the third-party content delivery exchange. Alternatively, in the case of no content identification, backend server 260 may choose to fall back to a static image or ad content item.

### Client-Side Bidding V. Server-Side Bidding

In an embodiment, client-server architecture 230 implements client-side bidding. Client-side bidding involves code executing on the client device making a call to a content delivery exchange, such as content delivery exchange 120 or a third-party content delivery exchange. In this way, the client device interacts directly with the content delivery exchange.

In one variation of this approach, if a content delivery exchange does not have one or more content items or a certain amount of time elapses before receiving any content items from the content delivery exchange, then web page 240 makes a subsequent call to another content delivery exchange, such as another internal content delivery exchange (e.g., for a text content item) or a third-party content delivery exchange (e.g., for a display content item). The client device may repeat this process for each content delivery exchange in a so-called “waterfall approach.”

In another embodiment, frontend server 220 interacts with one or more content delivery exchanges on behalf of the client device and sends any received content items to the client device. This is referred to herein as “server-side bidding.” The client device may initiate the process by sending a request to frontend server 250 (over a network, such as a LAN, WAN, or the Internet).

Either way, the one or more content items may have been identified as part of a content item selection event conducted by a content delivery exchange, whether internal or external. If an external content delivery exchange, then the publisher system sends a request to the external content delivery exchange and waits for a response based on a content item selection event conducted by the external delivery exchange.

Server-side bidding may be implemented using a serial approach or a parallel approach. In the serial approach, frontend server 250 sends a request to an internal content delivery exchange (e.g., implemented at backend server 260), if there is no valid response within a certain period of time (e.g., 50 milliseconds), then frontend server 250 sends a request to an external content delivery exchange, and so forth, until frontend server 250 receives (from a content delivery exchange) one or more content items to provide to the client device.

In the parallel approach, frontend server 250 sends multiple requests simultaneously or near concurrently, each request directed to a different content delivery exchange. In some cases, frontend server 250 may receive a content item from multiple content delivery exchanges, in which case, frontend server 250 conducts a publisher-side content item selection event by selecting one of the received content items (using one or more selection criteria) and then transmits that content item to the client device.

### Page Zone

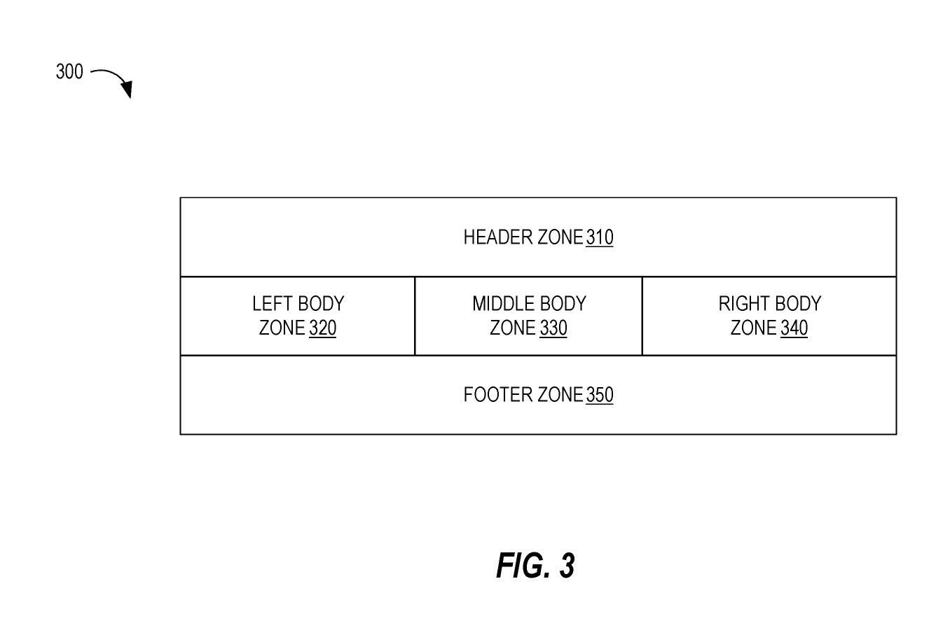

In an embodiment, a web page is divided into multiple zones (also referred to as sections or regions). FIG. 3 is a block diagram that depicts an example layout 300 of various zones within a web page, in an embodiment. In this example, a web page includes a header zone 310 at the top of the web page, a footer zone 350 at the bottom of the web page, and three body zones in the middle: a left body zone 320, a middle body zone 330, and right body zone 340. Other embodiments may include more or less zones, such as no header zone or footer zone and only two zones (e.g., only a left zone and a right zone). Another example layout is strictly vertical zone arrangement, such as a top zone, a middle zone, and a bottom zone.

A specified page zone may be used by a publisher system in one of multiple ways. For example, frontend server 250 may use a page zone indicated in a content item request to determine which set of one or more content delivery exchanges will be used to retrieve a content item for the content item request. For example, a header zone is associated with a first internal content delivery exchange while a body right zone is associated with a second internal content delivery exchange and an external content delivery exchange. In the last scenario, frontend server 250 may send requests to the content delivery exchanges in parallel or serially, in a waterfall approach.

Not only may a page zone parameter be used to dynamically decide which content item(s) to return, but a page zone parameter may be used to customize the layout and look and feel of the user interface. Thus, different page zones may have a different look and feel.

### Tile

In an embodiment, multiple content items may be displayed within a page zone. For example, in the above example layout, the right body zone (section #4) may include four content items. In this embodiment, each content item in a page zone of multiple content items is associated with a sequence number or “tile number” that indicates a relative position of the content item compared to the other content items in the page zone. For example, multiple content items within a page zone may be placed vertically, such that a content item associated with tile number 1 is placed at the top, a content item associated with the tile number 2 is placed below the previous content item, and so forth. As example, multiple content items within a page zone may be placed horizontally, such that a first content item associated with tile number 1 is placed to the left, a second content item associated with the tile number 2 is placed to the right of the first content item, and so forth.

In an embodiment, a client-side component specifies a tile number.

In an alternative embodiment, a client-side component does not specify a tile number. Instead, a content item manager (e.g., content item manager 232) determines a tile number for a content item. For example, a content item manager keeps track of how many client-side components that specify a particular page zone have been analyzed thus far for a particular web page. If the content item manager determines that the content item manager has not analyzed a client-side component that specified a particular page zone, then the corresponding resource identifier that the content item manager generates may include a ‘1’ for a tile number parameter. If the content item manager determines that the content item manager has previously analyzed one client-side component that specified a particular page zone, then the corresponding resource identifier that the content item manager generates may include a ‘2’ for a tile number parameter. If the content item manager determines that the content item manager has previously analyzed two client-side components that specified a particular page zone, then the corresponding resource identifier that the content item manager generates may include a ‘3’ for a tile number parameter.

Content item manager 232 may be implemented as a plugin to web page 240. In building the corresponding web application, developers may specify the plugin such that, when the web application is invoked to generate web page 240, content item manager 232 is transmitted to the client device in addition to web page 240. Content item manager 232 may be implemented in any programming language, an example of which is JavaScript. Thus, the code used to generate web page 240 is separate from the code of content item manager 232. A browser may execute content item manager 232 before any code related to the requested content of web page 240.

### Client-Side Components of a Web Page

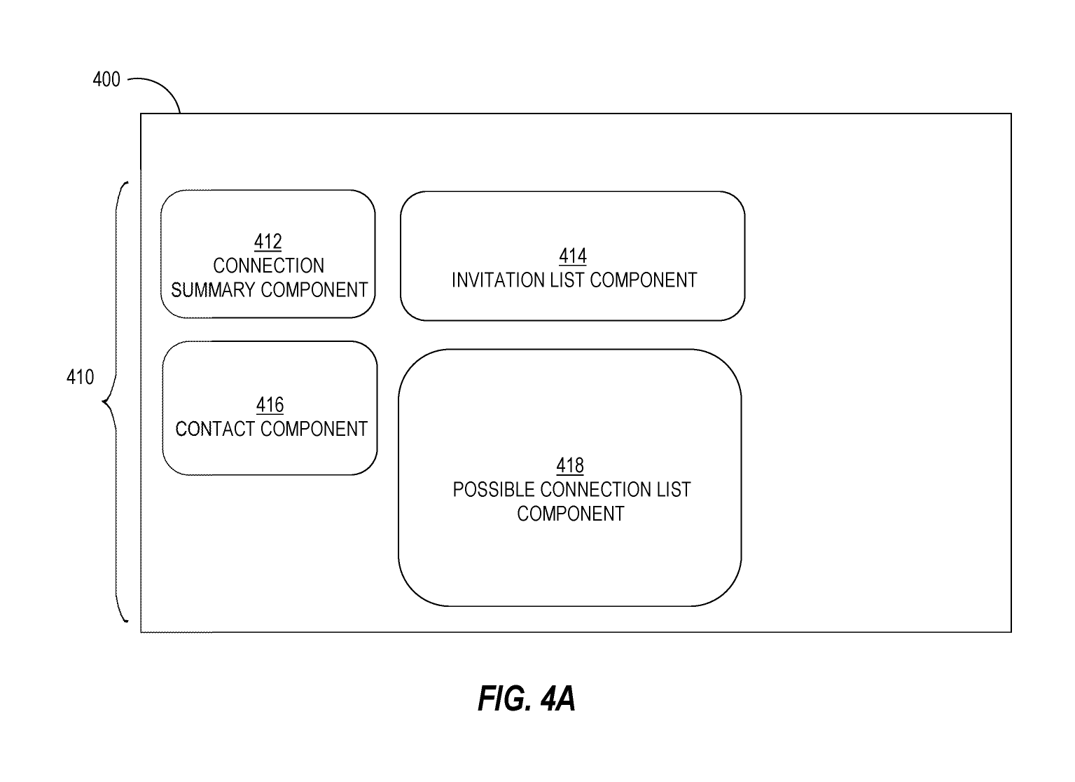

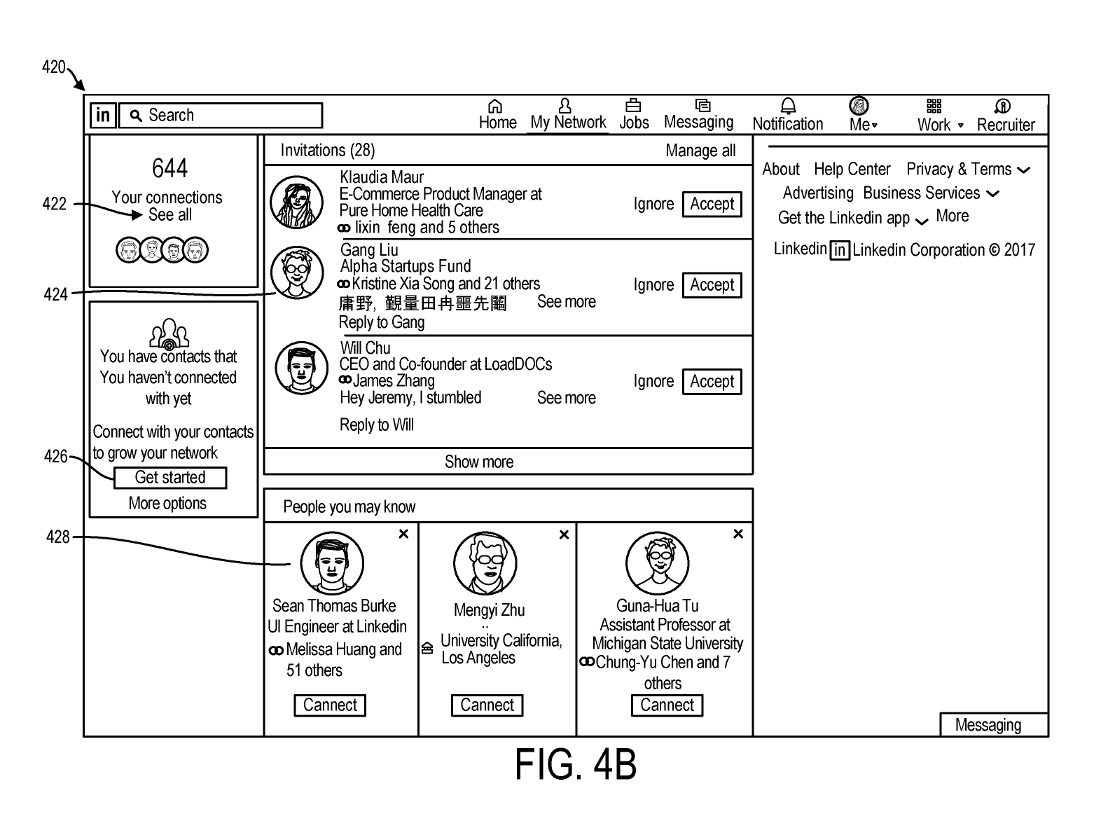

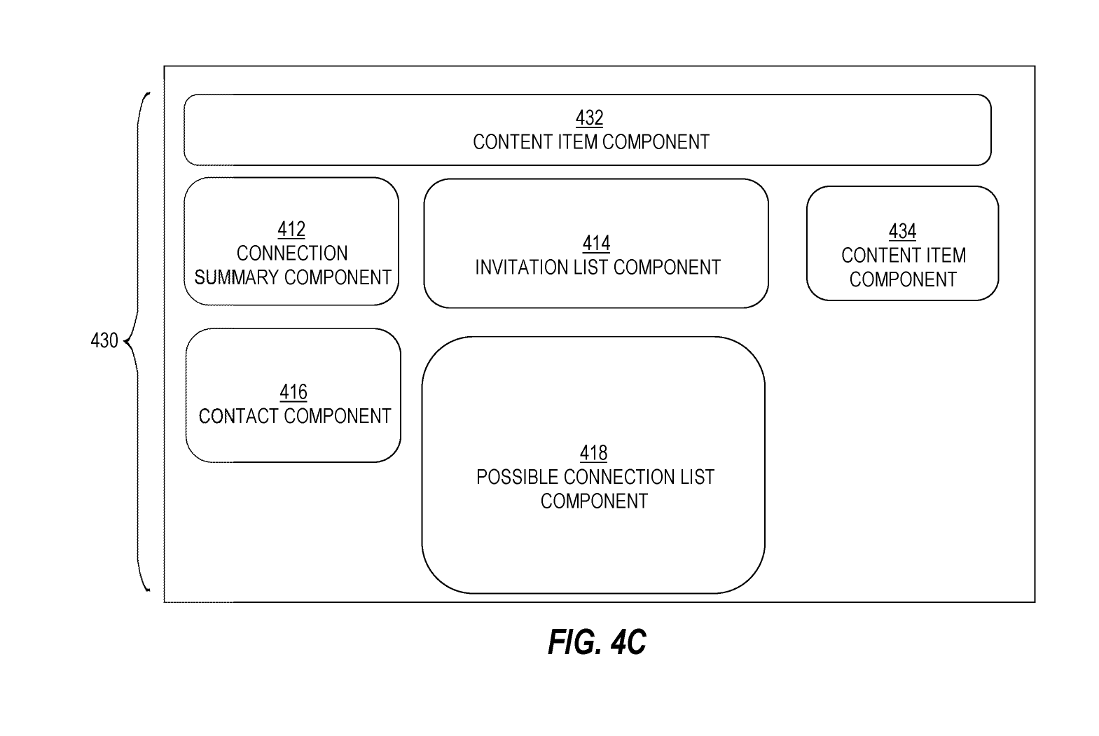

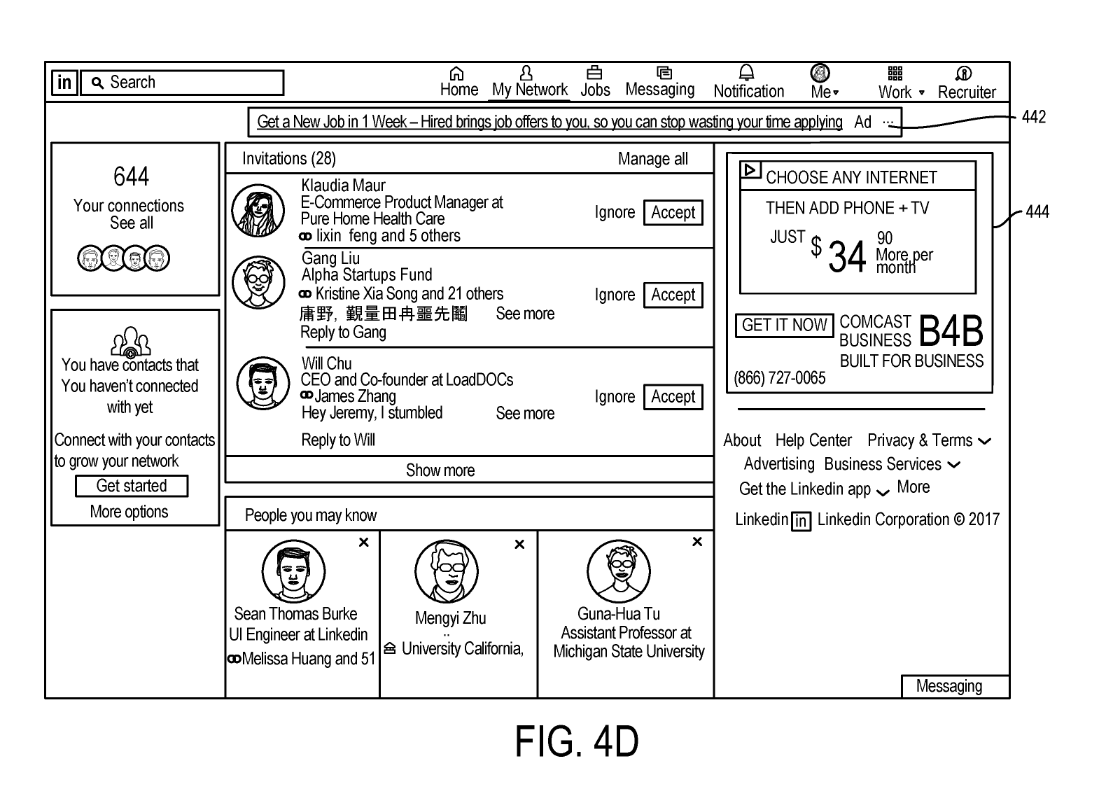

FIG. 4A depicts an example layout 410 of components for a particular web page 400, in an embodiment. Specifically, the particular web page is an example of a My Network web page (or tab in a single page application). Layout 410 includes a connection summary component 412, an invitation list component 414, a contact component 416, and a possible connection list component 418. Each of these components may be JavaScript components, although other embodiments are not so limited.

FIG. 4B depicts a screenshot of an example web page 420 that is generated based on layout 410. The processing of connection summary component 412 results in displaying a selectable icon 422 that allows the viewer to view her existing connections. The processing of invitation list component 414 results in displaying a list 424 of people who have invited the viewer to connect in a social network. The processing of contact component 416 results in displaying a selectable icon 426 that allows the viewer to send invitations to connect to contacts (of the viewer) who are not yet established connections of the viewer. The processing of possible connection list component 418 results in displaying a list 428 of people that the viewer might know but who are not yet established connections of the viewer.

FIG. 4C depicts an example layout 430 of components for the same web page as in FIG. 4A, except with additional components for retrieving additional content items, in an embodiment. Thus, layout 430 is similar to layout 410, except for content item components 432 and 434. The actual parameter values specified for each of components 432 and 434 may be different, such as different page zone parameter values and/or different tile numbers. For example, content item component 432 may specify a page zone parameter value indicating a header zone while content item component 434 may specify a page zone parameter value indicating a right body zone.

Although layout 430 indicates a relative final position on a resulting web page, where content item components 432 and 434 are located in code within the web page is not important. For example, content item components 432 and 434 may be the first components specified in web page code transmitted to a client device from a server, even though other components may be displayed prior to content item components 432 and 434. Also, content item component 434 may be specified before content item component 432 in the web page code, when content item component 432 may be displayed above content item component 434 in the resulting web page or may be displayed before content item component 434 is displayed in the resulting web page.

FIG. 4D depicts a screenshot of an example web page 440 that is similar to web page 420, except for content items that are retrieved in response to processing components 432 and 434. Thus, the processing of component 432 results in displaying content item 442 on web page 440 and the processing of component 434 results in displaying content item 444 on web page 442.

### Optional Parameters of a Client-Side Component

As noted above, a client-side component may include one or more required parameter values and one or more optional parameter values. Tile number (described previously) is an example of a parameter that is optional. An example of an optional parameter is an indication of whether a content item should “stick” to a web page as the web page is scrolled (e.g., based on user input). In other words, a web page initially includes, in an initial viewport, a slot in which a content item is displayed. A user then scrolls down the web page such that the current viewport includes entirely different content than the initial viewport. However, the content item is still displayed in roughly the same location or side of the web page as the initial state of the web page. Another example of an optional parameter is an indication of whether a content item should be refreshed when a refresh event is fired.

Examples of other optional parameters include a contextual entity member identifier (e.g., that identifies a person who is a subject of the web page, such as another user's profile page) and contextual data that indicates attributes of other elements of the corresponding web page. These optional parameters may be used by the system to identify and/or customize a content item to be displayed on the web page.

### Deferred Content Item Rendering

In an embodiment, a client-side component (e.g., client-side component 242) defers generating an executable element (e.g., an iframe) until a particular event is detected. Deferring the generation of an executable element effectively defers the generation of a content item request that includes a resource identifier. Once the particular event is detected, then client-side component 242 performs an action that enables a content item (or the corresponding executable element) to be rendered. An example action is setting a source (or “src”) attribute of the executable element.

The particular event that is detected may be an event that indicates that a window has been loaded (or a window.load event), a window that includes content that was generated by the server component of the web application executing at a publisher system. Another example of an event is when the main logic (e.g., data fetching) for a current route (or URL) has been executed. For a requested user profile page, once the user's profile data is loaded and displayed, then the executable element may be generated. In this way, latency for the main requested content may be reduced, but a content item request may be generated and transmitted before all content of the web page is rendered or before all logic within the web page has been executed.

Another example of an event is when a slot for a content item has (or is about to) come into the viewport. In fact, a certain portion or percentage of a slot in a viewport can be calculated (e.g., 50%) and used as a trigger to generate the executable element, which causes a content item request to be transmitted.

### Content Item Blocking

In some scenarios, a browser may include blocking software that prevents content items retrieved from calls or requests from the browser to third-party content delivery exchanges. The blocking software may automatically block such content items (as a default setting) or in response to input from a user operating the client device. One approach for blocking such content items is to include logic, within the web page, to not display the content items once the content items were retrieved. Thus, the requests for the content items are still being made. A disadvantage of this approach is that impressions are recorded even though the content items are not being displayed. As a result, any calculations of user selection rate or click-through rate (CTR) that are based on these impressions that did not in fact occur will be incorrect.

In an embodiment, client-side component 242 detects that blocking software is enabled in the browser and, in response, determines to not generate an executable element (e.g., an iframe) that references a particular endpoint, such as a third-party content delivery exchange. Instead, only executable elements that reference content available from the publisher system (or an internal content delivery exchange) are allowed to be generated. Thus, any impressions that are recorded will reflect what actually happened. An impression URL (e.g., that references fronted server 250) fires when it is detected that a content item associated with a client-side component is not going to be blocked. The actual timing of the firing is when the impression URL of the iframe is set so the browser makes a request to that impression URL.

Detection that blocking software is enabled may be performed in a number of ways. Content item manager 232 may analyze a web page and determine whether one or more signals are present. If so, then certain blocking software may be detected. As a specific example, content item manager 232 dynamically injects script files and, based on which one is loaded successfully, content item manager 232 learns of the blocking results. Different blocking software may result in making calls to certain content delivery exchanges, whether internal or external. For example, if one type of blocking software is detected, then a content request is not sent to any external content delivery exchange and instead to only internal content delivery exchanges, while if another type of blocking software is detected or confirmed to not be present, then a content request can be sent to all of multiple internal and external content delivery exchanges.

### Monitored Metrics

In an embodiment, a client-side component (e.g., client-side component 242) tracks one or more metrics. Example metrics include a latency of each content item request that is transmitted, a latency of each content item request that is transmitted to a third-party content delivery exchange, a number of content item requests transmitted, a number of successful responses (i.e., where a content item was identified by the called resource, such as backend server 260), a number of unsuccessful responses (i.e., where a content item was not identified by the called resource), and a number of errors detected or exceptions raised while executing.

After tracking one or more metrics, the client-side component transmits the tracked metrics over a computer network to a remote server, such as frontend server 250 (or a certain endpoint of frontend server 250) or another server altogether. The transmission may involve generating a resource identifier (e.g., a URL) that includes a web domain, that indicates one or more parameters (each representing a different metric), and that specifies a value for each of the one or more parameters.

### Server-Side Decisions

In an embodiment, a publisher system or content delivery exchange (e.g., content delivery exchange 120) uses one or more parameters indicated in a content item request to determine how a content item is to be displayed. For example, if a content item request indicates that a zone (or page type) parameter has a value of “MYNETWORK” and indicates that a page zone parameter has a value of “header”, then any selected content item needs to have text color of while because the header portion of MYNETWORK web pages have a dark background. Otherwise, any text in a content item that is displayed on that particular page should have a darker text color (e.g., black or dark blue) because other page zones have a white background. In this way, web developers are not required to keep track of these types of scenarios on the client side. Instead, those responsible for displaying content items concurrently with user requested content can make changes on the server side.

### Benefits

Replacing hardcoded content item requests with a centralized client-side framework has numerous advantages. For example, a client-side component that generates iframes on-the-fly can decrease loading time through asynchronous content item requests transmitted to a frontend server, as opposed to hardcoded content item requests, which can delay the loading of content of the requested web page. Another advantage is consistent user experience across all (or multiple) web pages of a web domain since developers of different web applications can simply plug in the code for the client-side component. Otherwise, different developers of different web applications are likely to implement content item requests differently.

Another advantage of the centralized approach is that maintenance of content item retrieval and rendering is greatly simplified. In the hardcoded approach, change to code of one web application might necessitate a change to code of one or more other web applications.

Another advantage of the centralized approach is the flexibility for future enhancements. Instead of having to implement an enhancement multiple times, one for each web application, the enhancement is made once and its benefit is realized when the client-side component is executed with each client portion of the web application. For example, if a publisher wishes to implement a parallel approach to server-side bidding as opposed to a waterfall approach in client-side bidding, then the code for the client-side component is changed instead of requiring developers of any affected web applications to change their respective code bases. As another example, if a publisher wishes to have certain content item requests directed to a different endpoint at a frontend server, then a single change of the client-side component code may be made opposed to a change to each hard-coded client-side call made by each affected web application.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

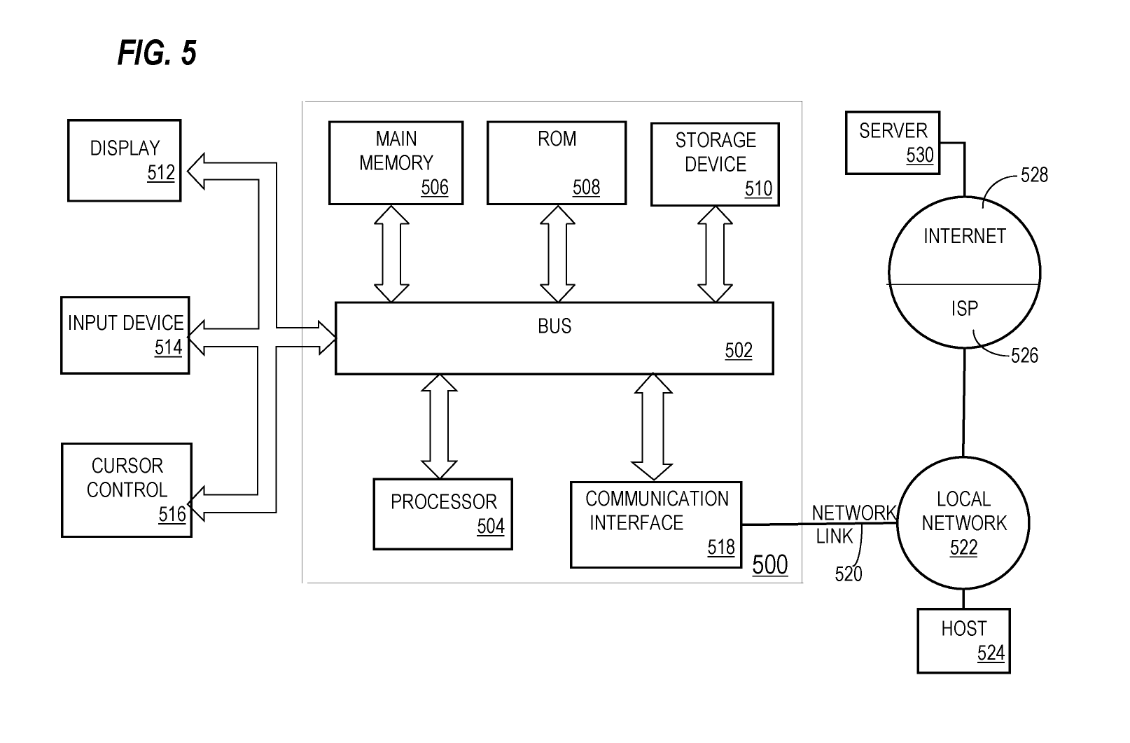

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
one or more processors;
one or more storage media storing instructions which, when executed by the one or more processors, cause:
receiving, at a client device, from a server, data that includes first code and a web document;
processing the data at the client device, wherein processing the data comprises:
analyzing the web document to identify a first component that specifies a first plurality of data items;
executing code associated with the first component to generate a first reference that is based on the first plurality of data items, generate a first executable element, and insert the first reference into the first executable element;
executing, at the client device, the first executable element, wherein executing the first executable element causes a first request that includes the first reference to be transmitted over a network;
receiving, in response to the first request, a first content item that is to be displayed within a web page that is rendered based on the web document.

2. The system of claim 1, wherein:
processing the data further comprises:
analyzing the web document to identify a second component that specifies a second plurality of data items;
executing code associated with the second component to generate a second reference that is based on the second plurality of data items, generate a second executable element, and insert the second reference into the second executable element;
the instructions, when executed by the one or more processors, further cause:
executing, at the client device, the second executable element, wherein executing the second executable element causes a second request that includes the second reference to be transmitted over the network;
receiving, in response to the second request, a second content item that is to be displayed within the web page that is rendered based on the web document.

3. The system of claim 2, wherein:
the first component specifies a first page zone within the web page;
the second component specifies a second page zone, within the web page, that is different than the first page zone.
the first content item is displayed within the first page zone;
the second content item is displayed within the second page zone.

4. The system of claim 2, wherein:
generating the first reference is also based on a first tile number;
processing the data further comprises:
after generating the first reference, determining that the first tile number has already been used;
in response to determining that the first tile number has already been used, generating the second reference based on a second tile number that is different than the first tile number;
the first tile number and the second tile number indicate relative positions within a particular zone of the web page.

5. The system of claim 1, wherein the plurality of data items includes two or more of a page type that indicates one of a plurality of page types, a page zone that indicates one of a plurality of possible page zones within the web page, or a slot size.

6. The system of claim 1, wherein generating the first reference comprises including, in the first reference, viewer data that is associated with a user of the client device or contextual data that is associated with an entity that is a subject of content within the web document.

7. The system of claim 1, wherein the instructions, when executed by the one or more processors, further cause:
generating, by a browser executing on the client device, the web page based on the web document;
wherein the browser executes the executable element;
wherein the executable element is an inline frame.

8. The system of claim 1, wherein processing the data further comprises:
validating the plurality of data items prior to generating the executable element;
wherein the executable element is only generated in response to determining that the plurality of data items are valid.

9. The system of claim 1, wherein processing the data further comprises:
prior to generating the executable element, determining whether one or more loading criteria are satisfied;
wherein the executable element is only generated in response to determining that the one or more loading criteria are satisfied.

10. The system of claim 9, wherein the one or more loading criteria includes whether a certain portion of a slot, within the web page, into which an anticipated content item is to be inserted, is visible.

11. The system of claim 1, wherein processing the data further comprises:
determining whether a content item blocker is enabled;
in response to determining that a content item blocker is enabled, refraining from generating an executable element that includes a reference that references a particular endpoint.

12. A method comprising:
receiving, at a client device, from a server, data that includes first code and a web document;
processing the data at the client device, wherein processing the data comprises:
analyzing the web document to identify a first component that specifies a first plurality of data items;
executing code associated with the first component to generate a first reference that is based on the first plurality of data items, generate a first executable element, and insert the first reference into the first executable element;
executing, at the client device, the first executable element, wherein executing the first executable element causes a first request that includes the first reference to be transmitted over a network;
receiving, in response to the first request, a first content item that is to be displayed within a web page that is rendered based on the web document;
wherein the method is performed by one or more computing devices.

13. The method of claim 12, wherein:
processing the data further comprises:
analyzing the web document to identify a second component that specifies a second plurality of data items;
executing code associated with the second component to generate a second reference that is based on the second plurality of data items, generate a second executable element, and insert the second reference into the second executable element;
the method further comprising:
executing, at the client device, the second executable element, wherein executing the second executable element causes a second request that includes the second reference to be transmitted over the network;
receiving, in response to the second request, a second content item that is to be displayed within the web page that is rendered based on the web document.

14. The method of claim 13, wherein:
the first component specifies a first page zone within the web page;
the second component specifies a second page zone, within the web page, that is different than the first page zone.
the first content item is displayed within the first page zone;
the second content item is displayed within the second page zone.

15. The method of claim 13, wherein:
generating the first reference is also based on a first tile number;
processing the data further comprises:
after generating the first reference, determining that the first tile number has already been used;
in response to determining that the first tile number has already been used, generating the second reference based on a second tile number that is different than the first tile number;
the first tile number and the second tile number indicate relative positions within a particular zone of the web page.

16. The method of claim 12, wherein the plurality of data items includes two or more of a page type that indicates one of a plurality of page types, a page zone that indicates one of a plurality of possible page zones within the web page, or a slot size.

17. The method of claim 12, wherein generating the first reference comprises including, in the first reference, viewer data that is associated with a user of the client device or contextual data that is associated with an entity that is a subject of content within the web document.

18. The method of claim 12, wherein processing the data further comprises:
validating the plurality of data items prior to generating the executable element;
wherein the executable element is only generated in response to determining that the plurality of data items are valid.

19. The method of claim 12, wherein processing the data further comprises:
prior to generating the executable element, determining whether one or more loading criteria are satisfied;
wherein the executable element is only generated in response to determining that the one or more loading criteria are satisfied.

20. The method of claim 12, wherein processing the data further comprises:
determining whether a content item blocker is enabled;
in response to determining that a content item blocker is enabled, refraining from generating an executable element that includes a reference that references a particular endpoint.
